(19) United States
(12) Patent Application Publication
(10) Pub. No.: US 2022/0288905 A1
(43) Pub. Date: Sep. 15, 2022

(54) FLEXIBLE STORAGE TANK

(71) Applicant: Raven Industries, Inc., Sioux Falls, SD (US)

(72) Inventors: Steven G. Redford, Brandon, SD (US); Derek Lee Coover, Sioux Falls, SD (US); Kyle P. Schroeder, Sioux Falls, SD (US)

(21) Appl. No.: 17/350,504

(22) Filed: Jun. 17, 2021

Related U.S. Application Data
(63) Continuation-in-part of application No. 17/196,366, filed on Mar. 9, 2021.

(51) Int. Cl. B32B 27/12; B32B 1/00; B32B 27/32; B32B 27/28; B32B 27/36; B32B 27/34; B32B 27/30; B32B 27/20; B32B 5/02; B65D 90/02

(52) U.S. Cl. CPC B32B 27/12; B32B 1/00; B32B 27/32; B32B 27/288; B32B 27/36; B32B 27/34; B32B 27/306; B32B 27/304; B32B 27/322; B32B 27/20; B32B 5/024; B32B 5/022; B65D 90/022; B32B 2439/40; B32B 2307/414; B32B 2307/412; B32B 2262/101; B32B 2262/0261; B32B 2262/08; B32B 2262/0276; B32B 2262/106; B32B 2262/0253; B32B 2260/021; B32B 2260/046; B32B 2262/062

(57) ABSTRACT

Various aspects of the present disclosure relate to a sealed storage tank. The sealed storage tank includes a first film. The first film includes a first polymeric layer having a thickness in a range of from about 0.05 mm to about 1 mm. The first film further includes a first fibrous scrim layer directly contacting the first polymeric layer. The first fibrous scrim layer has a denier value in a range of from about 500 denier to about 1500 denier. The sealed storage tank further includes a second film. The second film includes a second polymeric layer having a thickness in a range of from about 0.05 mm to about 1 mm. The second film further includes a second fibrous scrim layer directly contacting the second polymeric layer. The second fibrous scrim layer has a denier value in a range of from about 500 denier about 1500 denier.

### RELATED APPLICATIONS

This application is a continuation-in-part of U.S. patent application Ser. No. 17/196,366, filed Mar. 9, 2021 which is incorporated herein by reference in its entirety.

### BACKGROUND

Polymeric storage tanks can be used to store various types and quantities of liquids. However, a polymeric storage tank may not have sufficient strength to withstand the dynamic forces to which it can he exposed. To counter this, the thickness of the polymeric storage tanks may be increased or reinforcing layers may be incorporated into the polymeric storage tank. There can be drawbacks to this however, including making it difficult or impossible to see through the polymeric tank, increasing weight of the storage tank, decreasing the flexibility of the tank, or a combination thereof.

### SUMMARY OF THE INVENTION

Various aspects of the present disclosure relate to a sealed storage tank. The sealed storage tank includes a first film. The first film includes a first polymeric layer having a thickness in a range of from about 0.05 mm to about 1 mm. The first film further includes a first fibrous scrim layer directly contacting the first polymeric layer. The first fibrous scrim layer has a denier value in a range of from about 500 denier to about 1500 denier. The sealed storage tank further includes a second film. The second film includes a second polymeric layer having a thickness in a range of from about 0.05 mm to about 1 mm. The second film further includes a second fibrous scrim layer directly contacting the second polymeric layer. The second fibrous scrim layer has a denier value in a range of from about 500 denier about 1500 denier. A weld joins the first film and the second film.

### BRIEF DESCRIPTION OF THE FIGURES

The drawings illustrate generally, by way of example, but not by of limitation, various embodiments of the present invention.

FIG. 1 is a sectional view of a sealed storage tank.

FIG. 2 is a top view of a portion of the sealed storage tank of FIG. 1.

FIG. 3 is a sectional view of another sealed storage tank.

FIG. 4 is a schematic view of a lap weld of the storage tank of FIG. 3.

FIG. 5 is a schematic view of a prayer weld of the storage tank of FIG. 3.

FIG. 6 is a schematic view of a prayer weld of the storage tank of FIG. 3

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values e.g.,(1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise. the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to he understood that the phraseology or terminology employed herein, and not otherwise defined, is for the purpose of description only and not of limitation. Any use of section headings is intended to aid reading of the document and is not to he interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “organic group” as used herein refers to any carbon-containing functional group. Examples can include an oxygen-containing group such as an alkoxy group, aralkyloxy group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The terra “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N (R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 2.0 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms. or 2 to about 20 carbon atoms. or 2 to 12 carbon atoms or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —CH≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, otr cycloalkylalkyl. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4- 2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus, aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The term “amine” as used herein refers to primary, secondary, and tertiary amines having, e.g., the formula N(group)₃ wherein each group can independently be H or non-H, such as alkyl, aryl, and the like. Amines include but are not limited to R-NH₂, for example, alkylamines, arylamines, alkylarylamines; R₂NH wherein each R is independently selected, such as dialkylamines, diarylamines, aralkylamines, and the like; and R₃N wherein each R is independently selected, such as trialkylamines, dialkylarylamines, alkyldiarylamines, triarylamines, and the like. The term “amine” also includes ammonium ions as used herein.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to h number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

The term “weight-average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, and sedimentation velocity.

As used herein, the term “polymer” refers to a molecule having at least one repeating unit and can include copolymers.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

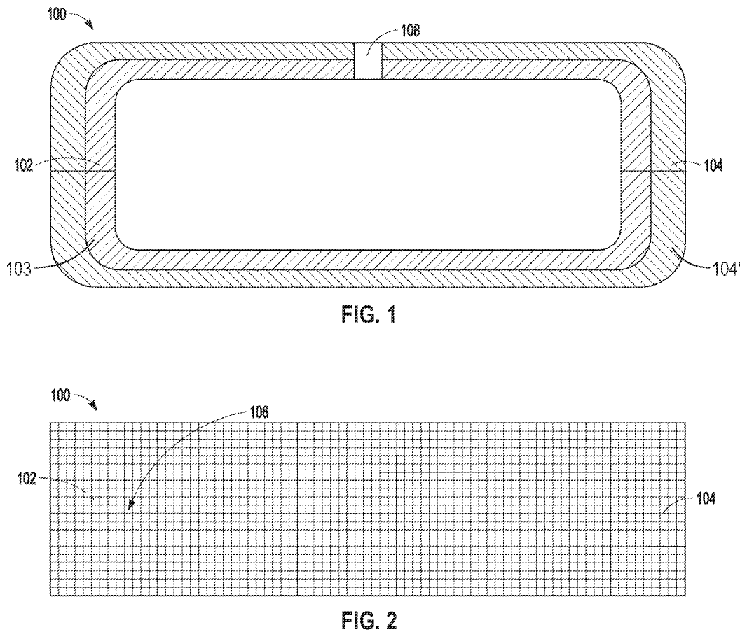

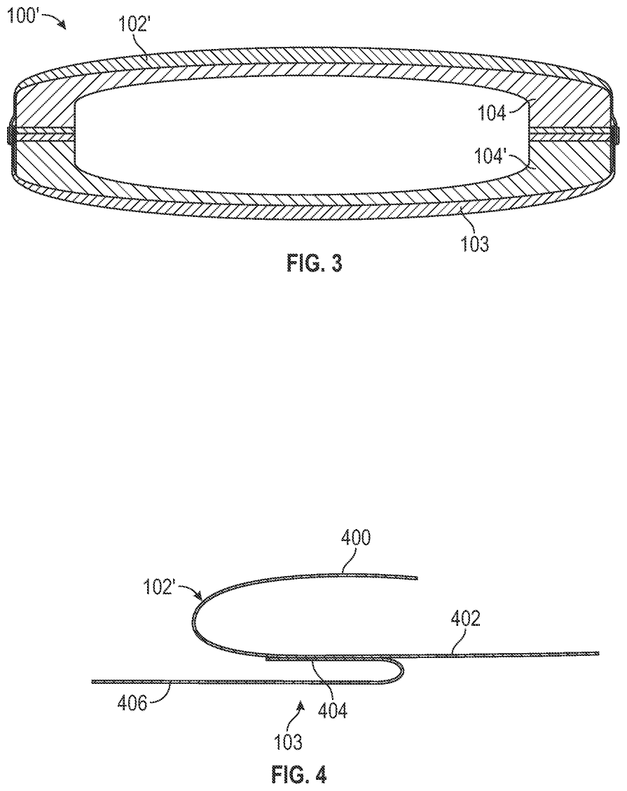

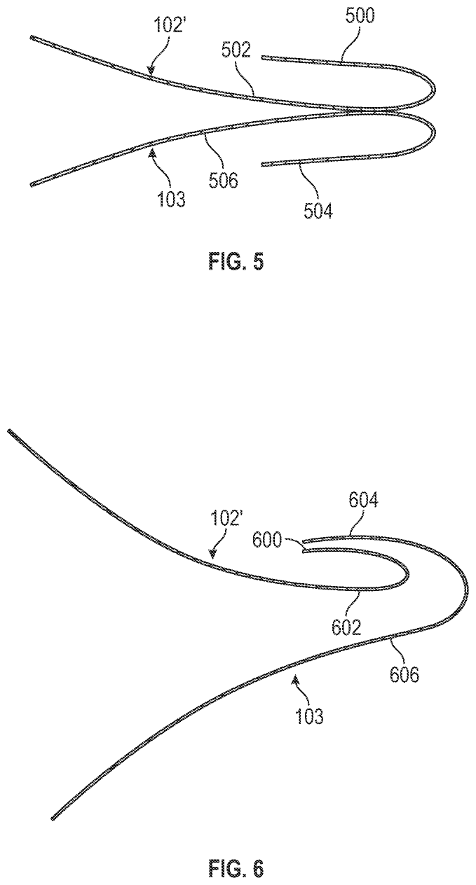

Described herein are various examples of a sealed storage tank. The sealed storage tank is adapted to contain a liquid. In some example, however, the sealed storage tank can include a solid. The solid can be liquified initially to fill the sealed storage tank, where it can then solidify in the tank, and then reliquefy to discharge (e.g., a wax or frozen liquid). In some examples, a liquid can be in a semi-frozen (e.g., slurry) state. The sealed storage tank can be pressurized or non-pressurized. FIG. 1 is a sectional view of sealed storage tank 100, FIG. 2 is a top-view of a portion of sealed storage tank 100. FIG. 3 shows another example of a sealed storage tank 100′. FIG. 4 shows a lap weld of the sealed storage tank of FIG. 3. FIG. 5 shows a prayer weld of the sealed storage tank of HG. 3. FIG. 6 shows another example of a prayer weld of the sealed storage tank of FIG. 3, FIGS. 1-6 discuss many of the same components and are discussed concurrently.

Sealed storage tanks 100 and 100′ includes first polymeric layer 102′, second polymeric layer 103 fibrous scrim layers 104 and 104′, and port 108. As shown in FIG. 1, fibrous scrim layer 104 or 104′ forms an external surface of polymeric layer 100 and is not fully embedded within polymeric layer 102. As shown in FIG. 3, separate fibrous scrim layers 104 or 104′ are internally disposed in first polymeric layer 102′ and second polymeric layer 103, respectively. As shown, polymeric layers 102, 102′, and 103 are each a monolayer (e.g., is not a multi-layer construction). Polymeric layers 102, 102′, and 103 can independently have a thickness in a range of from about 0.05 mm to about 1 mm, about 0.2.0 mm to about 0.30 mm, less than, equal to, or greater than about 0.05 mm, 0.10, 0.15, 0.20, 0.25, 0.30, 0.35, 0.40, 0.45, 0.50, 0.55, 0.60, 0.65, 0.70, 0.75, 0.80, 0.85, 0.90, 0.95, or about 1 mm. The thickness of polymeric layers 102, 102′, and 103 can independently be uniform or variable. The thickness values listed can be an absolute value or an average value.

Polymeric layer 102, 102′, and 103 can be substantially transparent or translucent. The transparent or translucent nature of polymeric layer 102, 102′, or 103 can allow a liquid disposed within storage tank 100 or 100′ to be visible to a degree. This can allow for quick confirmation that a liquid is successfully contained therein. In some examples, however, polymeric layer 102, 102′, or 103 (or a combination thereof) are substantially opaque.

Polymeric layer 102, 102′, and 103 can include a polyolefin, a polyketone, a polyester, a polyamide, ethylene vinyl alcohol, a polyvinylidene fluoride, a polyvinylidene chloride, a polyvinyl alcohol, a polytetrafluoroethylene, copolymers thereof, or a mixture thereof. The polyolefin can include a polyethylene, a polypropylene, a copolymer thereof, or a mixture thereof. In examples where polymeric layer 102, 102′, or 103 includes a mixture of materials, any individual material can be present in a range of from about 2.5 wt % to about 99.9 wt % of polymeric layer 102, 102′, or 103 about 50 wt % to about 95 wt %, less than, equal to, or greater than about 2.5 wt %, 5, 10, 15, 120, 25, 30, 35, 40, 45, 50, 55, 60, 65, 70, 75, 80, 85, 90, 95, or about 99.9 wt %.

Examples of suitable polyethylenes include an ultra-high molecular weight polyethylene (UHMWPE), a high-density polyethylene (HDPE), a cross-linked polyethylene (PEX or XLPE), a medium density polyethylene (MDPE), a linear low-density polyethylene (LLDPE), a metailocene catalyzed linear low-density polyethylene (mLLDPE), a low-density polyethylene (LDPE), a very low-density polyethylene (VLDPE), an ultra low-density polyethylene (ULDPE), a copolymer thereof, or a combination thereof.

Where present, a polyketone can be any suitable polyketone. An example of a suitable polyketone can include a polyketone including a repeating unit having the structure according to Formula I:

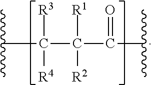

In Formula I, R¹, R², R³ and R⁴ can be independently chosen from —H, —OH, substituted or unsubstituted (C₁-C₂₀) hydrocarbyl. In further examples the (C₁-C₂₀)hydrocarbyl is chosen from (C₁-C₂₀)alkyl, (C₁-C₂₀)alkenyl, (C₁-C₂₀)alkynyl, (C₁-C₂₀)acyl, (C₁-C₂₀)cycloalkyl, (C₁-C₂₀)aryl, and (C₁-C₂₀)alkoxy, combinations thereof.

In additional embodiments, the polyketone can be a copolymer that includes repeating units having the structures according to Formula II:

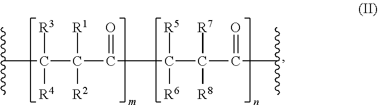

In Formula II, R¹, R², R³, R⁴, R⁵, R⁶, R⁷, and R⁸ can be independently chosen from —H, —OH, substituted or unsubstituted (C₁-C₂₀)hydrocarbyl. In further embodiments, the (C₁-C₂₀)hydrocarbyl can be chosen from (C₁-C₂₀)alkyl, (C₁-C₂₀)alkenyl, (C₁-C₂₀)alkynyl, (C₁-C₂₀)acyl, (C₁-C₂₀)cycloalkyl, (C₁-C₂₀)aryl, and (C₁-C₂₀)alkoxy, combinations thereof. In further embodiments R⁸ can be —CH₃. In further embodiments, R¹, R², R³, R⁴, R⁵, R⁶, R⁷, and R⁸ can each be —H. In any embodiment of Formula II, a degree of polymerization of m and n are positive integers and the repeating can be in random, block, or alternating configuration.

In embodiments where the polyketone is a copolymer, the polyketone can include any suitable additional repeating units. For example, the polyketone copolymer can include a repeating unit derived from ethylene, propylene, vinyl chloride, vinylidene chloride, styrene, acrylonitrile, tetrafluoroethylene, methyl methacrylate, vinyl acetate, isoprene, chloroprene, or a mixture thereof.

Polymeric layer 102, 102′, or 103 may include one polyketone or a mixture of polyketones. If polymeric layer 102, 102′, or 103 includes a mixture of polyketones, the polyketones can differ by composition (e.g., different repeating units or arrangement of repeating units). Furthermore, individual polyketone polymers can have different weight-average molecular weights. The weight-average molecular weight of any individual polyketone can be in a range of from about 5000 Daltons to about 50,000 Daltons, about 15,000 Daltons to about 25,000 Daltons, or less than, equal to, or greater than about 5,000 Daltons, 10,000, 15,000, 20,000, 25,000, 30,000, 35,000, 40,000, 45,000, or about 50,000 Daltons.

Polymeric layer 102, 102′, or 103 can include any suitable additive or mixture of additives to help impart various properties therein. Examples of additives that can be include a plasticizer additive, an antistatic additive, an antioxidant additive, a UV-resistance additive, a flame resistivity additive, or a mixture thereof. Where present, the additive, or mixture of additives, can he present in polymeric layer 100 in a range of from about 0.05 wt % to about 10 wt %, about 0.30 wt % to about 5 wt %, less than, equal to, or greater than about 0.05 wt %, 0.10, 0.5, 1, 1.5, 2, 2.5, 3, 3.5, 4, 4.5, 5, 5.5, 6, 6.5, 7, 7.5, 8, 8.5, 9, 9.5, or about 10 wt %.

Where present, the plasticizer can help to increase the flexibility and resilience of polymeric layer 102, 102′, or 103. While not so limited, examples of suitable plasticizers include bis(2-ethylhexyl) phthalate, bis(2-propylheptyl) phthalate, diisononyl phthalate, di-n-butyl phthalate, butyl benzyl phthalate, diisodecyl phthalate, dioctyl phthalate, diethyl phthalate, diisobutyl phthalate, di-n-hexyl phthalate, triniethyl trimellitate, tri-(2-ethylhexyl) trimellitate, tri-(n-octyl,n-decyl) trimellitate, tri-(heptyl,nonyl) trimellitate, n-octyl trimellitate, bis(2-ethylhexyl)adipate, dimethyl adipate, monomethyl adipate, dioctyl adipate, dibutyl sebacate, dibutyl maleate, diisobutyl maleate, triethyl citrate, acetyl triethyl citrate, tributyl citrate, acetyl tributyl citrate, trioctyl citrate, acetyl trioctyl citrate, trihexyrl citrate, acetyl trihexyl citrate, butyryl trihexyl citrate, trimethyl citrate, or a mixture thereof.

Examples of suitable flame retardants include, for example, organophosphorus compounds such as organic phosphates (including trialkyl phosphates such as triethyl phosphate, tris(2-chloropropyl)phosphate, and triaryl phosphates such as triphenyl phosphate and diphenyl cresyl phosphate, resorcinol bis-diphenylphosphate, resorcinol diphosphate, and aryl phosphate), phosphites (including trialkyl phosphites, triaryl phosphites, and mixed alkyl-aryl phosphites), phosphonates (including diethyl ethyl phosphonate, dimethyl methyl phosphonate), polyphosphates (including melamine polyphosphate, ammonium polyphosphates), polyphosphites, polyphosphonates, phosphinates (including aluminum tris(diethyl phosphinate); halogenated fire retardants such as chlorendic acid derivatives and chlorinated paraffins; organobromines, such as decabromodiphenyl ether (decaBDE), decabromodiphenyl ethane, polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD); metal hydroxides such as magnesium hydroxide, aluminum hydroxide, cobalt hydroxide, and hydrates of the foregoing metal hydroxide; and combinations thereof. The flame retardant can be a reactive type flame-retardant (including polyols which contain phosphorus groups, 10-(2,5-dihydroxyphenyl)-10H-9-oxa-10-phospha-phenanthrene-10-oxide, phosphorus-containing lactone-modified polyesters, ethylene glycol bis(diphenyl phosphate), neopentylglycol bis(diphenyl phosphate), amine- and hydroxyl-functionalized siloxane oligomers). These flame retardants can be used alone or in conjunction with other flame retardants. Where present, an antistatic additive allows for the dissipation of static charges which can help prevents fires.

Polymeric layer 102, 102′, or 103 can have a very low permeability to various liquids. With specific reference to a volatile organic compound, a permeability of polymeric layer 102, 102′, or 103, and therefore sealed storage tank 100 or 100′ can be in a range of from about 1×10⁻¹⁴m²/s to about 30×10⁻¹⁴ m²/s, about 1.4×10⁻¹⁴m²/s to about 25×10⁻¹⁴ m²/s, less than, equal to, or greater than about 1×10⁻¹⁴ m²/s, 1.4×10⁻¹⁴, 2×10⁻¹⁴, 2.5×10⁻¹⁴, 3×10⁻¹⁴, 4×10⁻¹⁴, 5×10⁻¹⁴, 6×10⁻¹⁴, 7×10⁻¹⁴,8×10⁻¹⁴, 9×10⁻¹⁴, 10×10⁻¹⁴, 11×10⁻¹⁴, 12×10⁻¹⁴, 13×10⁻¹⁴, 14×10⁻¹⁴, 15×10⁻¹⁴, 16×10⁻¹⁴, 17×10⁻¹⁴, 18×10⁻¹⁴, 19×10⁻¹⁴, 20×10⁻¹⁴, 21×10⁻¹⁴, 22×10⁻¹⁴,23×10¹⁴, 24×10⁻¹⁴, 25×10⁻¹⁴, 26×10⁻¹⁴, 27×10⁻¹⁴, 28×10⁻¹⁴, 29×10⁻¹⁴, or about 30×10⁻¹⁴ m²/s.

With respect to a volatile organic compound, the volatile organic compound can be a constituent of petroleum. Examples of volatile organic compounds can include an aromatic hydrocarbon, a chlorinated hydrocarbon, or a mixture thereof. Examples of aromatic hydrocarbon include benzene, toluene, ethylbenzene, xylene, or a mixture thereof. Examples of chlorinated hydrocarbon include 1,2-dichlorodhane (1,2-DCA), dichloromethane (DCM), trichloroethylene (TCE), tetrachloroethylene (PCE), or a mixture thereof.

The permeability of polymeric layer 102, 102′, or 103 can be enhanced or augmented by including a barrier layer in storage tank 100. Where present, the barrier layer can be disposed adjacent to an interior side of polymeric layer 102, 102′, or 103. Specifically, the barrier layer can be disposed on the interior of storage thank 100 and attached to polymeric layer 102, 102′, or 103. A thickness of the barrier layer can be between about 0.005 mm to about 0.05 mm, about 0.015 mm to about 0.02 mm, less than, equal to, or greater than about 0.005 mm, 0.006, 0.007, 0.008, 0.009, 0.01, 0.02, 0.03, 0.04, or about 0.05 mm. The barrier layer can include any suitable material or mixture of materials. For example, the barrier layer can include ethylene vinyl alcohol, a polyketone, a polyester, a polyvinylidene fluoride, a polyvinylidene chloride, a polyvinyl alcohol, a polytetrafluoroethylene, a polyamide, a metalized film, copolymers thereof, or a mixture thereof.

As shown in FIG. 1, fibrous scrim layer 104 or 104′ forms the exterior of storage tank 100. Fibrous scrim layer 104 or 104′ is in direct contact with polymeric layer 102. Fibrous scrim layer 104 or 104′ can be adhered to polymeric layer 100 or partially embedded within polymeric layer 102. If fibrous scrim layer 104 or 104′ is partially embedded within polymeric layer 102, it is not fully embedded within polymeric layer 102. If fibrous scrim layer 104 or 104′ is adhered to polymeric layer 102, the adhesive used can be a pressure-sensitive adhesive. The adhesive used can be a substantially transparent or substantially translucent adhesive. As another example, fibrous scrim 104 or 104′ can be adhered to polymeric layer 100 using a hot film. For example, fibrous scrim 104 or 104′ can be placed in contact with polymeric layer 100 and a hot film can be extruded over fibrous scrim to encapsulate it and provide adhesion to polymeric layer by seeping through openings 106. In some examples, the hot film can include a material to help improve abrasion resistance, grip, or another mechanical property. As shown in FIG. 3, fibrous scrim 104 or 104′ is fully embedded in polymeric layers 102′ and 103.

Fibrous scrim 104 or 104′ can include a woven or non-woven material comprising fiber glass, nylon, cotton, cellulosic fiber, wool, rubber, a polyester, carbon fiber, a polyolefin, a coextruded material, or a mixture thereof. An example of a suitable coextruded material can include a polyethylene-polyethylene terephthalate coextruded material. A denier value of fibrous scrim layer 104 or 104′ can be in a range of from about 500 denier to about 1500 denier, about 700 denier to about 1200 denier, less than, equal to, or greater than about 500 denier, 550, 600, 650, 700, 750, 800, 850, 900, 950, 1000, 1050, 1100, 1150, 1200, 1250, 1300, 1350, 1400, 1450, or about 1500 denier. Denier or den (abbreviated D), a unit of measure for the linear mass density of fibers, is the mass in grams per 9000 meters of the fiber. The denier is based on a natural reference: a single strand of silk is approximately one denier; a 9000-meter strand of silk weighs about one gram. In general, the higher the denier, the thicker the fiber. The denier values described. herein are for a polyetherterepthalate or an equivalent fiber. Therefore, the values described here can be used as a basis for determining the denier value of a fibrous scrim layer 104 or 104′ that uses a different material. In some examples, fibrous scrim 104 or 104′ can include an electronically conductive material. This can Kelp to provide flame resistance.

Overall, a thickness of fibrous scrim 104 or 104′ can be in a range of from about 0.10 mm to about 0.50 mm, about 0.20 mm to about 0.40 mm, less than, equal to, or greater than about 0.10, 0.15, 0.20, 0.25, 0.30, 0,35, 0.40, 0,45, or about 0.50 mm. The thickness of fibrous scrim 104 or 104′ can be uniform or variable. The thickness values listed for fibrous scrim 104 or 104′ can be absolute values or an average value of the thickness of fibrous scrim 104 or 104′. Fibrous scrim 104 or 104′ acts to protect polymeric layer 102, 102′, or 103 from contacting an external object that can damage polymeric layer 102, 102′, or 103. fibrous scrim 104 or 104′ can help to achieve this benefit in at least two ways. For example, the thickness of fibrous scrim 104 or 104′ can be thick enough that an object cannot be reasonably expected to penetrate fibrous scrim 104 or 104′ to contact or fully puncture polymeric layer 102, 102′, or 103. In some other examples, any of openings 106 defined by individual fibers of fibrous scrim 104 or 104′, may be small enough that an object, or a portion thereof, cannot fit through opening 106 to contact polymeric layer 102, 102′, or 103. As shown in FIG. 2, openings 106 have a quadrilateral shape. In further examples, openings 106, can independently have a circular shape, triangular shape, quadrilateral shape, or pentagonal shape. Each opening 106 can have the same shape. Alternatively, each opening 106 can have a different shape or a first plurality of openings 106 can have a first shape while a second plurality of openings 106 can have a second shape that is different from the first shape of the first plurality of openings.

Fibrous scrim 104 or 104′ can be understood to be a mono- or multi-filament material. The filaments described herein can include a single material or a plurality of coextruded materials. The material of fibrous scrim 104 or 104′ can he either woven or non-woven. Fibrous scrim 104 or 104′ as shown includes openings 106, but in some examples, fibrous scrim 104 or 104′ can be free of openings 106. In some examples, fibrous scrim 104 or 104′ can be coated with a material to enhance bonding with polymeric layer 102, 102′, or 103. The coating on fibrous scrim 104 or 104′ can also be coated with a conductive material, or formed from a conductive material, to help prevent static build-up.

The ability of fibrous scrim 104 or 104′ to protect polymeric layer 102, 102′, or 103 can be a function of the thickness of fibrous scrim 104 or 104′ and the size of openings 106. The thinner fibrous scrim 104 or 104 is, the smaller opening 106 needs to be. This is because a thinner fibrous scrim 104 or 104′ may not be thick enough to prevent an object from contacting or fully puncturing polymeric layer 102, 102′, or 103 so the size of openings 106 can be decreased to help prevent an object from passing therethrough to contact polymeric layer 102, 102′, or 103. Conversely, the thicker fibrous scrim 104 or 104′ is, the larger openings 106 can be. This is because fibrous scrim 104 or 104′ may be thick enough that even if an object can fit through opening 106, it may not be able fully penetrate opening 106 to reach polymeric layer 102, 102′, or 103.

A limiting factor on how small openings 106 can be is that at least some portion of polymeric layer 102, 102′, or 103 should be visible through fibrous scrim layer 104 or 104′. A benefit to polymeric layer 102, 102′, or 103 being substantially translucent or transparent is that the liquid disposed therein can be observed therethrough. If openings 106 are too small, it may not be possible to see a sufficient amount of polymeric layer 102, 102′, or 103 so that the liquid disposed therein can be seen. Therefore, openings 106 or a portion of the total number of openings 106 need to be sized large enough to allow at least some of polymeric layer 102, 102′, or 103 to be visible therethrough.

Sealed storage tank 100 can include a liquid. The liquid can be pressurized or non-pressurized. Examples of suitable liquids can include water, an alcoholic beverage, a hydrocarbon, or a mixture thereof. Examples of hydrocarbons can include a petroleum. Examples of alcoholic beverages can include wine. The substantially transparent or translucent nature of polymeric layer 102, 102′, or 103 can be particularly beneficial if the liquid disposed therein is wine. This is because the wine can be readily observed and a user can tell if the wine contained therein is a white wine or a red wine.

The volume of sealed storage tank 100 can be designed for any desired application. For example, sealed storage tank 100 can be designed to hold small volumes of liquid or a large volume of liquid. As an example, a volume of sealed storage tank 100 can be in a range of from about 4 liters to about 40,000 liters, 1000 liters to about 10,000 liters, less than, equal to, or greater than about 4 liters, 100, 500, 1,000, 2,000, 5,000, 10,000, 20,000, 30,000, 40,000, 50,000, 60,000, 70,000, 80,000, 90,000, 100,000, 150,000, 200,000, 250,000, 300,000, 350,000, 400,000, 450,000, or about 500,000 liters. Additionally, sealed storage tank 100 can contain a pressurized liquid. For example, sealed storage tank 100 can contain a liquid pressurized in a range of from about 1 atm to about 5 atm, about 1 atm to about 3 atm, less than, equal to, or greater than about 1 atm, 2 atm, 3 atm, 4 atm, or 5 atm. The ability to contain pressurized liquids can be helpful if storage tank 100 is intended to store a carbonated beverage such as beer or soda pop.

Liquid can be provided to or removed from sealed storage tank 100 through port 108. In further examples, port 108 can be configured as a sealable vent or valve. Although only one port 108 is shown, it is possible for sealed storage tank 100 to include a plural number of ports, vents, or valves.

Sealed storage tank 100 or 100′ can be included in a larger assembly. For example, sealed storage tank or 100′ can be disposed at least partially within a container. The container can be a metal container, a plastic container, or a combination thereof. The container can partially or fully enclose sealed storage tank or 100′. The container can help to protect sealed storage tank or 100′ during transportation. Sealed storage tank or 100′ can be attached to the container or can be free of attachment within the container. If sealed storage tank or 100′ is attached to the container, attachment can be accomplished, for example, by welding, clamping, adhesion, or a combination thereof.

Sealed storage tank or 100′ can be manufactured in many suitable ways. Manufacturing can include producing polymeric layers 102, 102′, or 103. Polymeric layer 102, 102′, or 103 can be formed, for example, by a blown film extrusion process. Polymeric layer 102, 102′, or 103 can be produced as a sheet or as a tube. Ends of polymeric layer 102, 102′, or 103 can be joined to form a sealed structure of polymeric layer 102, 102′, or 103. The ends of polymeric layer 102, 102′, or 103 can be joined, for example, by a thermal weld, an adhesive, or both. Joining the ends of polymeric layer 102, 102′, or 103 can form one or more longitudinal seams (e.g., along a major length of polymeric layer 102, 102′, or 103). The thermal weld can form a joint such as a butt joint, tee joint, corner joint, lap joint, or edge joint.

Fibrous scrim 104 or 104′ can be joined to polymeric layer 102, 102′, or 103 before or after the ends of polymeric layer 102, 102′, or 103 are joined. Additionally, in examples where polymeric layer 102, 102′, or 103 is extruded, fibrous scrim 104 or 104′ can be coextruded therewith. Fibrous scrim 104 or 104′ can be adhered to polymeric layer 102, 102′, or 103 through a number of different techniques, as described herein above. For example, if polymeric layer 102, 102′, or 103 is a thermoplastic polymer, polymeric layer 102, 102′, or 103 can be heated to, or near, its glass transition temperature to soften it and fibrous scrim 104 or 104′ can be partially embedded therein. Additionally, polymeric layer 102, 102′, or 103 and fibrous scrim 104 or 104′ can be joined by a thermal weld, an adhesive, or a combination thereof.

If polymeric layer 102, 102′, or 103 and fibrous scrim 104 or 104′ are joined by an adhesive, the adhesive can be polypropylene, a pressure sensitive adhesive, a thermosensitive adhesive, a thermoset adhesive, a polyurethane, an ethylene methyl acrylate, an ethylene vinyl acetate, an epoxy, a polyurethane, a polyolefin, or a combination thereof. In some examples, it can be desirable for the adhesive to be substantially transparent or substantially translucent. This can he helpful if the adhesive is intentionally or unintentionally applied over a portion of polymeric layer 102, 102′, or 103. If the adhesive is substantially transparent or translucent, polymeric layer 102, 102′, or 103 and the contents of sealed storage tank 100 can still be seen therethrough.

In examples where fibrous scrim 104 or 104′ is fully embedded in polymeric layer 102, 102′, or 103, fibrous scrim 104 or 104′ can be coextruded with polymeric layer 102, 102′, or 103. In examples where fibrous scrim 104 or 104′ is fully embedded in polymeric layer 102, 102′, or 103 it is desirable to seal off the ends of polymeric layers 102, 102′, or 103. This is desirable to prevent moisture from creeping into fibrous scrim 104 or 104′. Additionally, sealing off the end can help to prevent fibrous scrim 104 or 104′ from being pulled through and out of polymeric layer 102, 102′, or 103.

The ends can be sealed according to many suitable methods. For example, the ends of sealed storage tank 100′ can be sealed and joined by a weld. The weld can extend along a longitudinal seam of the side of sealed storage tank 100′ between polymeric layers 102′ and 103. The weld can also extend about an end of sealed tank 100′ between polymeric layers 102′ and 103. Generally, a major dimension of the longitudinal seam is greater than a major dimension of the end of sealed tank 100′. There are various welds that can be used to seal the ends. The welds can be a “standard” weld, For example, polymeric layer 102′ and 103 can be brought into contact and welded directly together. However, in certain examples, if fibrous scrim layer 104, 104′ or both are internally disposed within polymeric layer 102′ and 103, respectively, different welds can be used to help prevent fibrous scrim 104, 104′, or both from slipping out of the polymeric layer into which they are disposed. Examples of suitable welds that can help prevent slipping include a “fold-over weld” such as a lap weld and a prayer weld.

An example of a lap weld is shown in FIG. 4. As shown in FIG. 4, the lap weld is formed by folding first leading portion 400 of polymeric film 102′ about 180 degrees relative to first trailing unfolded portion 402 of polymeric film 102′. Similarly, second leading portion 404 of the polymeric film 103 is folded about 180 degrees relative to second trailing unfolded portion 406 of the polymeric film 103. After folding, first trailing portion 402 and second trailing portion 406 are contacted and welded to form a joint or a seal. Optionally, the joint or seal formed can be sewn to further strengthen the joint. If the weld is a lap weld, sewing may only be between first leading portion 400, first trailing portion 402, and second trailing portion 406. This is because the welded joint is likely to contact. the liquid stored in sealed tank 100. If first trailing portion 402 were included in the sewing, it could increase the risk that a puncture could let the liquid pass therethrough to the exterior of the tank.

FIG. 5 shows an example of a prayer weld that can be used. As shown in FIG. 5, the prayer weld is formed by folding third leading portion 500 of polymeric layer 102′ about 180 degrees relative to fourth trailing portion 502 of polymeric layer 102′. Additionally, fifth leading portion 504 of polymeric layer 103 is folded about 180 degrees relative to sixth trailing portion 506 of polymeric layer 102′. After folding, fourth trailing portion 502 and sixth trailing portion 506 are contacted and welded to form a joint or a seal. Optionally, the joint or seal formed can be sewn to further strengthen the joint. Unlike the example of a lap weld, sewing can occur through each of third leading portion 500, fourth trailing portion 502, fifth leading portion 504, and sixth trailing portion 506.

FIG. 6 shows an example of another prayer weld that can be used. The prayer weld can include seventh leading portion 600 of polymeric layer 102′, folded about 180 degrees relative to eighth trailing unfolded portion 602 of the polymeric layer 102′. The prayer weld further includes nineth leading portion 604 of second polymeric layer 103, folded about 180 degrees relative to tenth trailing unfolded portion 606 of second polymeric layer 103. Seventh folded leading portion 600 of first polymeric layer 100 and tenth folded leading portion 606 of the second polymeric layer 103 and the eighth trailing portion 602. of the first polymeric layer 102′ and the tenth trailing portion 606 of the second polymeric layer 103 are contacted and welded to form a joint that is optionally sewn.

Any combination of the lap welds and prayer welds described herein can be used to form sealed storage tank 100′. In some alternative examples first polymeric layer 100 and second polymeric layer 103 can be joined without weld. For example, they can be joined by folding a metal band along a seam between first polymeric layer 102′ and second polymeric layer 103. Alternatively, a plastic slide can be engaged with the seam between first polymeric layer 102′ and second polymeric layer 103.

In another alternative example, it may be possible for either first polymeric layer 102′ or second polymeric layer 103 to be free of reinforcing scrim 104 or 104′. A construction such as this can be useful if one layer is designated as a bottom layer and therefore not likely to be exposed to potentially destructive forces that can be mitigated by fibrous scrim 104 or 104′.

There are various non-limiting advantages associated with sealed storage tank 100 or 100′, at least some of which are unexpected. These advantages are particularly apparent when compared to other sealed storage tanks. For example, comparative storage tanks may be formed from a single polymeric layer. However, in order for such a storage tank to be able to withstand the dynamic forces to which it will be exposed, the thickness must be much thicker than polymeric layers 102, 102′, or 103. In contrast, fibrous scrim 104 or 104′ provides sealed storage tank 100 or 100′ with enough strength to allow for polymeric layers 102, 102′, or 103 to be comparatively thinner than the comparative single polymeric layer sealed storage tanks. Other comparative sealed storage tanks can be formed using a plurality of polymeric layers. Each of the plurality of polymeric layers can be about 0.12 mm to about 0.25 mm thick. The innermost layer is meant to contain the liquid and the outer layers are meant to abrade as sacrificial layers when subjected dynamic forces. Compared to this sealed storage tank, the construction of sealed storage tank 100 or 100′ is much easier to construct. Additionally, sealed storage tank 100 does not include materials that are intended to be a sacrificial material and therefore the risk of failure of storage tank 100 or 100′ is reduced. Additionally, fibrous scrim 104 or 104′ is strong enough to protect polymeric layer 102, 102′, or 103 from contacting an object to such a degree that polymeric layer 102, 102′, or 103, can be significantly damaged.

An additional, non-limiting, advantage of sealed storage tank 100 or 100′ is its flexibility. The relatively thin construction of polymeric layer 102, 102′, or 103 compared to the other sealed storage tanks described above, can allow sealed storage tank 100 or 100′ to be folded to a higher degree and take up less space than those comparative sealed storage tanks. This can allow for more sealed storage tanks 100 or 100′ to be packed in a shipping crate. Additionally, the thinner construction can lead to sealed storage tank 100 or 100′ being less heavy than the comparative tanks described herein.

### Exemplary Aspects.

The following exemplary aspects are provided, the numbering of which is not to be construed as designating levels of importance:

Aspect 1 provides a sealed storage tank comprising:
a first film comprising:
   a first polymeric layer having a thickness in a range of from about 0.05 mm to about 1 mm; and
   a first fibrous scrim layer directly contacting the first polymeric layer, the first fibrous scrim layer having a denier value in a range of from about 500 denier to about 1500 denier;
a second film comprising:
   a second polymeric layer having a thickness in a range of from about 0.05 mm to about 1 mm: and
   a second fibrous scrim layer directly contacting the second polymeric layer, the second fibrous scrim layer having a denier value in a range of from about 500 denier to about 1500 denier; and
a weld joining the first film and the second film.

Aspect 2. provides the sealed storage tank of Aspect 1, further comprising a vent, a port, a valve, or a combination thereof extending through the first polymeric layer, the second polymeric layer, or both and the fibrous scrim layer.

Aspect 3 provides the sealed storage tank of any one of Aspects 1 or 2, having of volume of at up to about 200,000 liters.

Aspect 4 provides the sealed storage tank of any one of Aspects 1-3, having a volume in a range of from about 4 liters to about 40,000 liters.

Aspect 5 provides the sealed storage tank of any one of Aspects 1-4, having a volume in a range of from about 300 liters to about 10,000 liters.

Aspect 6 provides the sealed storage tank of any one of Aspects 1-5, wherein the thickness of the first polymeric layer, the second polymeric layer, or both is independently in a range of from about 0,20 mm to about 0.30 mm.

Aspect 7 provides the sealed storage tank of any one of Aspects 1-6, wherein the first polymeric layer, the second polymeric layer, or both independently comprises a polyolefin, a polyketone, a polyester, a polyamide, ethylene vinyl alcohol, a polyvinylidene fluoride, a polyvinylidene chloride, a polyvinyl alcohol, a polytetrafluoroethylene, copolymers thereof, or a mixture thereof.

Aspect 8 provides the sealed storage tank of Aspect 7, wherein the polyolefin comprises a polyethylene, a polypropylene, a copolymer thereof, or a mixture thereof.

Aspect 9 provides the sealed storage tank of Aspect 8, wherein the polyolefin comprises polyethylene.

Aspect 10 provides the sealed storage tank of any one of Aspects 8 or 9, wherein the polyethylene comprises an ultra high molecular weight polyethylene (UHMWPE), a high-density polyethylene (HDPE), a cross--linked polyethylene (PEX or XLPE), a medium density polyethylene (HDPE), a linear low-density polyethylene (LLDPE), a metallocene catalyzed linear low-density polyethylene (mLLDPE), a low-density polyethylene (LDPE), a very low-density polyethylene (VLDPE), an ultra low-density polyethylene (ULDPE), a copolymer thereof, or a combination thereof.

Aspect 11 provides the sealed storage tank of any one of Aspects 8-10, wherein the polyethylene comprises a high-density polyethylene (HDPE), a low-density polyethylene (LDPE), a copolymer thereof, or a mixture thereof,

Aspect 12 provides the sealed storage tank of any one of Aspects 7-11, wherein the polyolefin comprises a polyketone in a range of from about 2.5 wt % to about 100 wt % of the polymeric layer.

Aspect 13 provides the sealed storage tank of any one of Aspects 7-12, wherein polyketone comprises an aliphatic polyketone, an aromatic polyketone, or a mixture thereof.

Aspect 14 provides the sealed storage tank of any one of Aspects 7-13, wherein the polyketone comprises a repeating unit having the structure according to Formula I:

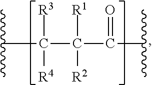

wherein R¹, R², R³ and R⁴ are independently chosen from —H, —-OH, and substituted or unsubstituted (C₁-C₂₀)hydrocarbyl.

Aspect 15 provides the sealed storage tank of Aspect 14, wherein the (C₁-C₂₀)hydrocarbyl is chosen from (C₁-C₂₀)alkyl, (C₂-C₂₀)alkenyl, (C2-C20)alkynyl, (C₁-C₂₀)cycloalkyl, (C₅-C₂₀)aryl, (C₁-C₂₀)alkoxy, and combinations thereof.

Aspect 16 provides the sealed storage tank. of any one of Aspects 14 or 15, wherein the polyketone comprises repeating units according to Formula II:

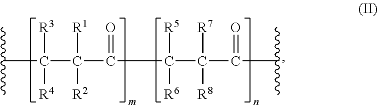

wherein

R¹, R², R³, R⁶, R⁷, and R8 are independently chosen from —H, —OH, and substituted or unsubstituted (C₁-C₂₀)hydrocarbyl,

wherein m and n are positive integers and represent a degree of polymerization, and

the repeating units shown in Formula II are in random, block, or alternating configuration.

Aspect 17 provides the sealed storage tank of any one of Aspects 14-16, wherein the (C₁-C₂₀)hydrocarbyl is chosen from (C₁-C₂₀)alkyl, (C₂-C₂₀)alkenyl, (C₂-C₂₀)alkynyl, (C₁-C₂₀)acyl, (C₂-C₂₀)cycloalkyl, (C₂-C₂₀)aryl, (C₁-C₂₀)alkoxy, and combinations thereof.

Aspect 18 provides the sealed storage tank of any one of Aspects 14-17, wherein R⁸ is —CH₃.

Aspect 19 provides the sealed storage tank of any one of Aspects 14-18, wherein R¹, R², R³, R⁴, R⁵, R⁶, R⁷, and R⁸ are each —H.

Aspect 20 provides the sealed storage tank of any one of Aspects 7-19, wherein the polyketone is a copolymer and further comprises a repeating unit derived from ethylene, propylene, vinyl chloride, vinylidene chloride, styrene, acrylonitrile, tetrafluoroethylene, methyl methacrylate, vinyl acetate, isoprene, chloroprene, or a mixture thereof.

Aspect 21 provides the sealed storage tank of any one of Aspects 7-20, wherein the first polymeric layer, the second polymeric layer, or both independently comprise a plurality of polyketone polymers having different weight-average molecular weights.

Aspect 22 provides the sealed storage tank of any one of Aspects 1-21, wherein the first polymeric layer, the second polymeric layer, or both independently comprise an additive comprising a plasticizer additive, an antistatic; additive, an antioxidant additive, a UV-resistance additive, or a mixture thereof.

Aspect 23 provides the sealed storage tank of Aspect 22, wherein the additive is independently present in the first polymeric layer, the second polymeric layer, or both in a range of from about 0.05 wt % to about 10 wt %.

Aspect 24 provides the sealed storage tank of any one of Aspects 22 or 23, wherein the additive is independently present in the first polymeric layer, the second polymeric layer, or both in a range of from about 0.30 wt % to about 5 wt %.

Aspect 25 provides the sealed storage tank of any one of Aspects 22-24, wherein the plasticizer comprises bis(2-ethylhexyl) phthalate, bis(2-propytheptyl) phthalate, diisononyl phthalate, di-n-butyl phthalate, butyl benzyl. phthalate, diisodecyl phthalate, dioctyl phthalate, diethyl phthalate, diisobutyl phthalate, di-n-hexyl phthalate, trimethyl trimellitate, tri-(2-ethylhexyl) trimellitate, tri n-octyl,n-decyl) trimellitate, tri-(hutyl,nonyl) trimellitate, n-octyl trimellitate, bis(2-ethylhexyl)adipate, dimethyl adipate, monomethyl adipate, dioctyl adipate, dibutyl sebacate, dibutyl maleate, diisobutyl maleate, triethyl citrate, acetyl triethyl citrate, tributyl citrate, acetyl tributyl citrate, trioctyl citrate, acetyl trioctyl citrate, trihexyl citrate, acetyl trihexyl citrate, butyryl trihexyl citrate, trimethyl citrate, or a mixture thereof.

Aspect 26 provides the sealed storage tank of any one of Aspects 1-25, wherein a permeability of the sealed storage tank to a volatile organic compound is in a range of from about 1×10⁻¹⁴m²/s to about 30×10^{—14} m²/s.

Aspect 27 provides the sealed storage tank of any one of Aspects 1-26, wherein a permeability of the sealed storage tank to a volatile organic compound is in a range of from about 1.4×10⁻¹⁴ m²/s to about 25×10⁻¹⁴ m²/s.

Aspect 28 provides the sealed storage tank of any one of Aspects 26 or 27, wherein the volatile organic compound comprises an aromatic hydrocarbon, a chlorinated hydrocarbon, or a mixture thereof.

Aspect 29 provides the sealed storage tank of Aspect 28, wherein the aromatic hydrocarbon comprises benzene, toluene, ethylbenzene, xylene, or a mixture thereof.

Aspect 30 provides the sealed storage tank of any one of Aspects 28 or 29, wherein the chlorinated hydrocarbon comprises 1,2-dichloroethane (1,2-DCA), dichloromethane (DCM), trichloroethylene (TCE) tetrachloroethylene (PCE), or a mixture thereof.

Aspect 31 provides the sealed storage tank of any one of Aspects 28-30, wherein the volatile organic compound is a constituent of petroleum.

Aspect 32 provides the sealed storage tank of any one of Aspects 1-31, further comprising a barrier layer independently disposed adjacent to an interior side of the first polymeric layer, the second polymeric layer, or both.

Aspect 33 provides the sealed storage tank of Aspect 32, wherein a thickness of the barrier layer is in a range of from about 0.005 mm to about 0.05 mm.

Aspect 34 provides the sealed storage tank of any one of Aspects 32 or 33, wherein a thickness of the barrier layer is in a range of from about 0.015 mm to about 0.02 mm.

Aspect 35 provides the sealed storage tank of Aspects 32-34, wherein the barrier layer comprises ethylene vinyl alcohol, a polyketone, a polyester, a polyvinylidene fluoride, a polyvinylidene chloride, a polyvinyl alcohol, a polytetrafluoroethylene, a polyamide, a metalized film, copolymers thereof, or a mixture thereof.

Aspect 36 provides the sealed storage tank of any one of Aspects 1-35, wherein the fibrous scrim comprises a woven or non-woven material comprising fiber glass, nylon, cotton, cellulosic! fiber, wool, rubber, a polyester, a carbon fiber, a polyolefin, a coextruded material, or a mixture thereof.

Aspect 37 provides the sealed storage tank of any one of Aspects 1-36, wherein the fibrous scrim layer has a denier value in a range of from about 700 denier to about 1200 denier.

Aspect 38 provides the sealed storage tank of any one of Aspects 1-37, wherein the fibrous scrim comprises a plurality of openings bounded by individual fibers of the fibrous scrim, the openings independently comprising a circular shape, triangular shape, quadrilateral shape, or pentagonal shape.

Aspect 39 provides the sealed storage tank of any one of Aspects 1-38, wherein the fibrous scrim is at least partially embedded in the first polymeric layer, the second polymeric layer, or both.

Aspect 40 provides the sealed storage tank of any one of Aspects 1-39, wherein the fibrous scrim is not fully embedded in the first polymeric layer, the second polymeric layer, or both.

Aspect 41 provides the sealed storage tank of any one of Aspects 1-40, further comprising a liquid, a solid, a slurry, or a mixture thereof, disposed within the sealed storage tank.

Aspect 42 provides the sealed storage tank of Aspect 41, wherein the liquid comprises, water, an alcoholic beverage, a hydrocarbon, or a mixture thereof.

Aspect 43 provides the sealed storage tank of Aspect 42, wherein the alcoholic beverage comprises wine.

Aspect 44 provides the sealed storage tank of any one of Aspects 43, wherein the weld comprises a lap weld, a prayer weld, or both.

Aspect 45 provides the sealed storage tank of Aspect 44, wherein the lap weld comprises:
a first leading portion of the first film, folded about 180 degrees relative to a first trailing unfolded portion of the first film;
a second leading portion of the second film, folded. about 180 degrees relative to a second trailing unfolded portion of the second film, wherein the first trailing portion of the first film and the second folded leading portion of the second film are contacted and welded to form a joint that is optionally sewed; and
the prayer weld comprises:
   a third leading portion of the first film, folded about 180 degrees relative to a fourth trailing unfolded portion of the first film;
   a fifth leading portion of the second film, folded about 180 degrees relative to a sixth trailing unfolded portion of the second film, wherein the third trailing portion of the first film and the fourth trailing portion of the second film are contacted and welded to form a joint that is welded; or
the prayer weld comprises
   a seventh leading portion of the first film, folded about 180 degrees relative to an eighth trailing unfolded portion of the first film;
   a nineth leading portion of the second film, folded about 180 degrees relative to a tenth trailing unfolded portion of the second film, wherein the seventh folded leading portion of the first film and the tenth folded leading portion of the second film and the eighth trailing portion of the first film and the tenth trailing portion of the second film are contacted and welded to form a joint that is optionally sewn.

Aspect 46 provides the sealed storage tank of any one of Aspects 44 or 45, wherein the lap weld seals a longitudinal joint between the first film and the second film and the prayer weld seals an end joint, wherein a major dimension of the end joint is less than a major dimension of the longitudinal joint.

Aspect 47 provides the sealed storage tank of any one of Aspects 1-46, wherein the composition of the first film is different from the composition of the second film.

Aspect 48 provides an assembly comprising:
the sealed storage tank of any one of any one of Aspects 1-45; and
a container, wherein the sealed storage tank is disposed at least partially within to the container.

Aspect 49 provides the assembly of Aspect 48, wherein the container is a metal container, a plastic container, or a combination thereof.

Aspect 48 provides the assembly of any one of Aspects 48 or 49, wherein the sealed storage tank is attached to the container.

Aspect 50 provides the assembly of Aspect 48, wherein the sealed storage tank is welded to the container.

Aspect 51 provides the assembly of any one of Aspects 48 or 49, wherein the sealed storage tank is clamped to the container.

Aspect 52 provides a method of making the sealed storage tank of any of Aspects 1-51, the method comprising welding the first film and the second film.

Aspect 53 provides the method of Aspect 52, wherein the welding comprises thermal welding.

What is claimed is:

1. A sealed storage tank comprising:
a first film comprising:
a first polymeric layer having a thickness in a range of from about 0.05 mm to about 1 mm; and
a first fibrous scrim layer directly contacting the first polymeric layer, the first fibrous scrim layer having a denier value in a range of from about 500 denier to about 1500 denier;
a second film comprising:
a second polymeric layer having a thickness in a range of from about 0.05 mm to about 1 mm; and
a second fibrous scrim layer directly contacting the second polymeric layer, the second fibrous scrim layer having a denier value in a range of from about 500 denier to about 1500 denier; and
a weld joining the first film and the second film.

2. The sealed storage tank of claim 1, wherein the first polymeric layer, the second polymeric layer, or both are substantially translucent or transparent and are at least partially visible through the first fibrous scrim layer, the second fibrous scrim layer, or both.

3. The sealed storage tank of claim 1, further comprising a vent, a port, a valve, or a combination thereof extending through at least one of the first film and the second film.

4. The sealed storage tank of claim 1, wherein the thickness of the first polymeric layer, the second polymeric layer, or both are independently in a range of from about 0.20 mm to about 0.30 mm.

5. The sealed storage tank of claim 1, wherein the first polymeric layer, the second polymeric layer, or both independently comprise a polyolefin, a polyketone, a polyester, a polyimide, ethylene vinyl alcohol, a polyvinylidene fluoride, a polyvinylidene chloride, a polyvinyl alcohol, a polytetrafluoroethylene, copolymers thereof, or a mixture thereof.

6. The sealed storage tank of claim 1, wherein the first polymeric layer, the second polymeric layer, or both comprise an additive comprising a plasticizer additive, an antistatic additive, an antioxidant additive, a UV-resistance additive, or a mixture thereof.

7. The sealed storage tank of claim 1, wherein a permeability of the sealed storage tank to a volatile organic compound is in a range of from about 1×10⁻¹⁴ m²/s to about 30×10⁻¹⁴ m²/s.

8. The sealed storage tank of claim 1, further comprising a barrier layer disposed adjacent to an interior side of the first polymeric layer, the second polymeric layer, or both.

9. The sealed storage tank of claim 1, wherein the first fibrous scrim layer, the second fibrous scrim layer, or both independently comprise a woven or non-woven material comprising fiber glass, nylon, cotton, cellulosic fiber, wool, rubber, a polyester, a carbon fiber, a polyolefin, a coextruded material, or a mixture thereof.

10. The sealed storage tank of claim 1, wherein the first fibrous scrim layer, the second fibrous scrim layer, or both independently have a denier value in a range of from about 700 denier to about 1200 denier.

11. The sealed storage tank of claim 1, wherein the first fibrous scrim layer, the second fibrous scrim layer, or both independently comprise a plurality of openings bounded by individual fibers of the first fibrous scrim layer, the second fibrous scrim layer, or both, the openings independently comprising a circular shape, triangular shape, quadrilateral shape, or pentagonal shape.

12. The sealed storage tank of claim 1, wherein the first fibrous scrim layer, the second fibrous scrim layer, or both are at least partially embedded in the first polymeric layer or the second polymeric layer.

13. The sealed storage tank of claim 1, wherein the first fibrous scrim layer, the second fibrous scrim layer, or both are fully embedded in the first polymeric layer or the second polymeric layer.

14. The sealed storage tank of claim 1, further comprising a liquid, a solid, a slurry, or a mixture thereof, disposed within the sealed storage tank.

15. The sealed storage tank of claim 1, wherein the weld comprises a lap weld, a prayer weld, or both.

16. The sealed storage tank of claim 15, wherein
the lap weld comprises:
a first leading portion of the first film, folded about 180 degrees relative to a first trailing unfolded portion of the first film;
a second leading portion of the second film, folded about 180 degrees relative to a second trailing unfolded portion of the second film, wherein the first trailing portion of the first film and the second folded leading portion of the second film are contacted and welded to form a joint that is optionally sewed; and
the prayer weld comprises:
a third leading portion of the first film, folded about 180 degrees relative to a fourth trailing unfolded portion of the first film;
a fifth leading portion of the second film, folded about 180 degrees relative to a sixth trailing unfolded. portion of the second film, wherein the third trailing portion of the first film and the fourth trailing portion of the second film are contacted and welded to form a joint that is welded; or
the prayer weld comprises
a seventh leading portion of the first film, folded about 180 degrees relative to an eighth trailing unfolded. portion of the first film;
a ninety leading portion of the second film, folded about 180 degrees relative to a tenth trailing unfolded portion of the second film, wherein the seventh folded leading portion of the first film and the tenth folded leading portion of the second film and the eighth trailing portion of the first film and the tenth trailing portion of the second film are contacted and welded to form a joint that is optionally sewn.

17. The sealed storage tank of claim 15, wherein the lap weld seals a longitudinal joint between the first film and the second film and the prayer weld seals an end joint, wherein a major dimension of the end joint is less than a major dimension of the longitudinal joint.

18. The sealed storage tank of claim 1, wherein the composition of the first film is different from the composition of the second film.

19. A method of making the sealed storage tank of claim 1, the method comprising welding the first film and the second film.

20. The method of claim 19, wherein the welding comprises thermal welding.
